(19) United States
(12) Patent Application Publication
(10) Pub. No.: US 2008/0016120 A1
(43) Pub. Date: Jan. 17, 2008

(54) System and method for case management

(76) Inventors: Yosi Markovich, Haifa (IL); Tal Davidson, Yoqneam Illit (IL)

Correspondence Address: PEARL COHEN ZEDEK LATZER, LLP, 1500 BROADWAY 12TH FLOOR, NEW YORK, NY, 10036, US

(21) Appl. No.: 11/812,851

(22) Filed: Jun. 22, 2007

Related U.S. Application Data
(60) Provisional application No. 60/817,099, filed on Jun. 29, 2006.

(51) Int. Cl. G06F 17/00

(52) U.S. Cl. 707/104.1

(57) ABSTRACT

A system for management of medical data, which includes an ingestible imaging capsule for capturing images in a patient's body and transmitting them to a receiving unit external to the patient's body. Transmitted image data that is received from the imaging capsule may be stored in the receiving unit and later downloaded to a work station for processing and analysis. A case management tool comprising a user interface allows a user to review and manage the analyzed data and additional data related to medical cases. A method for management of medical data includes finding updated data in medical archives, synchronizing associated cases in a case management database, summarizing the synchronized data and providing a user with the summarized data per case.

This application claims the benefit under 35 U.S.C. § 119(e) of U.S. Provisional Patent Application No. 60/817,099, filed Jun. 29, 2006, which is hereby incorporated herein by reference in its entirety.

### FIELD OF THE INVENTION

The present invention relates generally to a method and system for record keeping and database organization, and more specifically to a system and method for case management of data obtained during medical procedures.

### BACKGROUND OF THE INVENTION

Medical procedures may include analysis of data collected from a patient's body. Some medical procedures include obtaining images in vivo, from within a patient's body. For example, images of a person's gastrointestinal (GI) tract may be collected in endoscopic procedures. In vivo images may be collected by an in vivo imaging system which is carried by a swallowable capsule endoscope. The imaging system captures and transmits images of the GI tract to an external recording device while the capsule passes through the GI lumen. Such an in vivo imaging system provides a platform from which moving or still images of a GI tract may be viewed. Large numbers of images may be collected for viewing. For example, the images may be combined in sequence, and a moving image of, for example, 40 minutes in length, may be presented to the user.

Work stations are typically used to manage in vivo images collected by capsule endoscopes. A user may note findings while viewing the GI tract images and may prepare a report based on the findings and/or other analysis performed on the GI tract images. Typically, the information produced during the procedure is manually handled via different files and file formats and reports may be saved on different mediums and in different archives.

This file structure and working procedure may complicate user tasks (e.g., opening desired videos, findings or reports, long term storage, report creation as well as being able to assign data to a specific patient or procedure).

### SUMMARY OF THE INVENTION

Embodiments of the present invention provide a case-management system and method that can significantly simplify the data handling experience for users.

A system is provided, according to one embodiment, which includes an ingestible imaging capsule for imaging the GI tract and for transmitting images to a receiving unit, which is external to the patient. Transmitted image data that is received from the imaging capsule may be stored in the receiving unit and later downloaded to a work station for processing and review by a user. According to one embodiment a user may manage the data obtained during such procedures per case.

A system is provided, according to one embodiment, which includes an in vivo imaging device for capturing images in a patient's body. The device may include a transmitter for transmitting data representing said images. The system may include a receiver external to the patient's body for receiving the transmitted data, a data processor for analyzing the data, a storage unit and an image monitor capable of displaying analyzed data. The system may further include a case management with a user interface for presenting a list of all case related data elements per case.

A method and user interface are provided according to one embodiment, which include displaying cases on a workstation display in a typically summarizing graphic representation, such as a table, chart, graph, etc. According to one embodiment a summarized presentation may be constructed from data that is located on the workstation and/or in remote locations, such as portable memory devices. Preferably, the data presented in the summarized presentation is continuously or periodically updated so that a user is presented with the most updated information.

A method is provided according to one embodiment, which includes identifying case related data elements in archives. Embodiments of the invention include monitoring the archives continously for changes in data to find updated data. The updated data may be synchronized with data in a case management database. A summarized graphic representation may be presented per case based on analyzing the synchronized data.

Embodiments of the invention enable easy identification of cases and all related data, easy viewing of case data in different archives, easy opening of data and easy storage and export. Thus, for example, a user may conveniently use different devices or archives to store case information but may review all the cases at once in a summarized way in one location. Additionally, the possibility to cross reference studies that have been conducted on other workstations or locations allows physicians to access and view colleagues' cases.

### BRIEF DESCRIPTION OF THE DRAWINGS

The present invention will be understood and appreciated more fully from the following detailed description taken in conjunction with the drawings in which:

FIG. 1 shows a schematic diagram of an in-vivo imaging system according to one embodiment of the present invention;

FIG. 2 is a schematic presentation of a method and user interface according to one embodiment of the invention;

FIG. 3 depicts a method and user interface according to another embodiment of the invention;

FIG. 4 depicts a portion of a display according to an embodiment of the present invention; and

FIG. 5 depicts another portion of a display according to an embodiment of the present invention.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well-known features may be omitted or simplified in order not to obscure the present invention.

Unless specifically stated otherwise, it should be appreciated that throughout the specification discussions utilizing terms such as “processing”, “computing”, “storing”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. Such apparatuses may be specially constructed for the desired purposes, or may comprise general purpose computers selectively activated or reconfigured by a computer program stored in the computers. Such computer programs may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. It will be appreciated that a variety of programming languages may be used to implement the teachings of the invention as described herein.

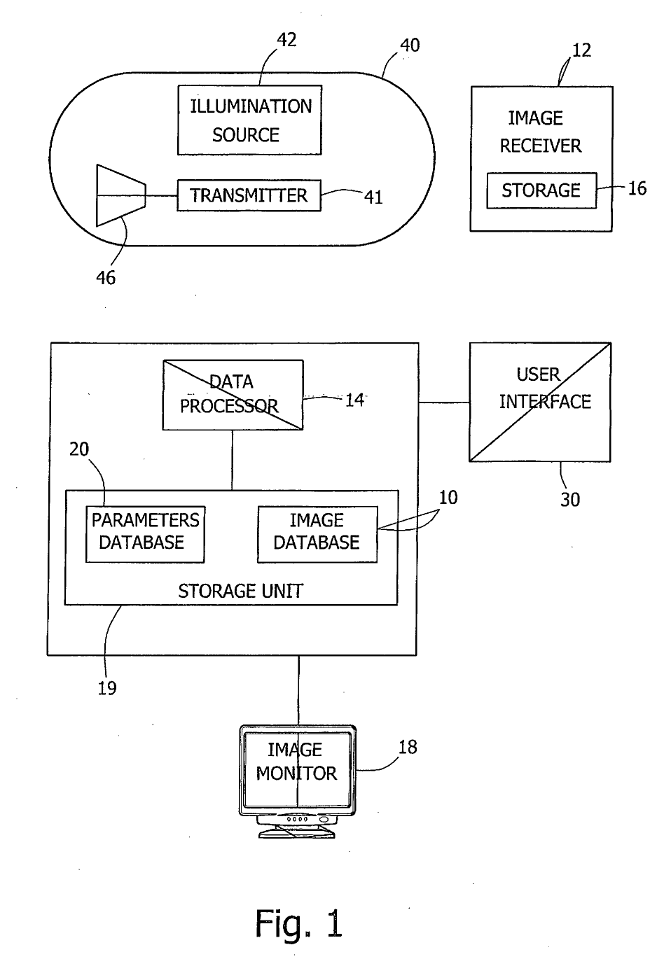

Reference is made to FIG. 1, which shows a schematic diagram of an imaging system according to one embodiment of the present invention. In an exemplary embodiment, the system may include an in vivo device 40, for example a capsule or other suitable device, having an imager 46, for capturing images, an illumination source 42, for illuminating the body lumen, and a transmitter 41, for transmitting and/or receiving data such as images and possibly other information to or from a receiving device. Preferably, the imager 46 is a suitable CMOS camera such as a “camera on a chip” type CMOS imager. In alternate embodiments, the imager 46 may be another device, for example, a CCD. According to some embodiments a 320×320 pixel imager may be used. Pixel size may be between 5 to 6 micron. According to some embodiments pixels may be each fitted with a micro lens. The illumination source 42 may be, for example, one or more light emitting diodes, or another suitable light source.

In alternate embodiments device 40 may be other than a capsule; for example, device 40 may be an endoscope, or other in vivo imaging device, etc. An optical system, including, for example, a lens or plurality of lenses, may aid in focusing reflected light onto the imager 46. The device 40 may be inserted into a patient by for example swallowing and preferably traverses the patient's GI tract. In certain embodiments, the device and image capture system may be similar to embodiments described in U.S. Pat. No. 5,604,531 and/or in U.S. Pat. No. 7,009,634 to Iddan et al., issued Mar. 7, 2006 both assigned to the common assignee of the present invention and incorporated by reference herein. In alternate embodiments, other image capture devices, having other configurations, and other image capture systems, having other configurations, may be used.

Preferably, the in vivo imaging system collects a series of still images as it traverses the GI tract. The images may be later presented as, for example, a stream of images or a moving image of the traverse of the GI tract. The in vivo imager system may collect a large volume of data, as the in vivo device 40 may take several hours to traverse the GI tract, and may record images at a rate of, for example, two-eight images every second, resulting in the recordation of thousands of images. The image recordation rate (or frame capture rate) may be varied.

Preferably, located outside the patient's body in one or more locations, are an image receiver 12, preferably including an antenna or antenna array, an image receiver storage unit 16, a data processor 14, a data processor storage unit 19, and an image monitor 18, for displaying, inter alia, the images recorded by the device 40 and other information. Preferably, the image receiver 12 and image receiver storage unit 16 are small and portable, and may be worn on the patient's body during receiving and recording of the images. Data processor storage unit 19 may include an image database 10 and a parameters database 20 e.g. a pathology parameters, scoring or other database, which may include for example a dictionary using medical terms or data such as Capsule Endoscopy Standard Terminology (CEST) which may be used for preparing a report e.g. a scoring report, for assessing a patient condition. Preferably, data processor 14, data processor storage unit 19 and monitor 18 are part of a personal computer or workstation which may include components such as processor 14, a memory, a disk drive, and input-output devices, although alternate configurations are possible, and the system and method of the present invention may be implemented on various suitable computing systems. Database 20 may be in other locations, for example, database 20 may be remote or accessed via a network such as the Internet. Database 20 may store information other than pathologies or CEST, for example case data, image data, patient history, video files, etc.

Data processor 14 may include any suitable data processor, such as a microprocessor, multiprocessor, accelerator board, or any other serial or parallel high performance data processor. Image monitor 18 may be a computer screen, a conventional video display, or any other device capable of providing image or other data. According to other embodiments a data processor may be included in image receiver 12 and images or other data may be displayed on a screen or display on image receiver 12.

In operation, imager 46 may capture images and may send data representing the images to transmitter 41, which may transmit images to image receiver 12 using, for example, radio frequencies. Image receiver 12 may transfer the image data to image receiver storage unit 16. According to one embodiment, after a certain time of data collection, the image data stored in storage unit 16 may be sent to the data processor 14 or the data processor storage unit 19. For example, the image receiver storage unit 16 may be taken off the patient's body and connected to a personal computer or workstation which includes the data processor 14 and data processor storage unit 19 via a standard data link, e.g., a serial or parallel interface of known construction. The image data may be then transferred from the image receiver storage unit 16 to the image database 10 within data processor storage unit 19. Data processor 14 may analyze the data and provide the analyzed data to the image monitor 18, where a health professional may view the image data. According to some embodiments the processing and/or displaying of images may be done on the image receiver 12.

Data processor 14 may operate software which, in conjunction with operating software such as an operating system and device drivers, may control the operation of data processor 14. Preferably, the software controlling data processor 14 includes code written in the C++ language and possibly additional languages, but may be implemented in a variety of known methods. According to some embodiments intermediate storage 16 need not be used. Data processor 14 may operate any suitable scoring calculation or calculation software or process to determine a final score based on several parameter marks or grades assigned by the user. The software, algorithm or processes used for scoring may be based on a numerical, logical or semantic computation involving parameter values, predetermined database constants and weights, terms and formulas.

The database 20 which may be included in storage unit 19 may be contained within for example a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storage. The database 20 may contain information related to each image, for example, scoring results, scoring formulas, text information, keywords, descriptions, a complete medical diagnosis, relevant cases, articles or images, for example, images of the close areas, images of pathology or any other information.

The image data collected and stored may be stored indefinitely, transferred to other locations or devices, manipulated or analyzed. According to some embodiments image data is not viewed in real time, other configurations allow for real time viewing.

The image monitor 18 may present the image data, preferably in the form of still and moving pictures, and in addition may present other information. In an exemplary embodiment, such additional information may include, but is not limited to a time line to show the time elapsed for each image, images in which a pathology, such as bleeding, had been identified, the location of the swallowable capsule in the patient's abdomen, etc. In an exemplary embodiment, the various categories of information are displayed in windows. According to some embodiments information that can aid a user in preparing a medical report may be displayed to the user while he is preparing the report. For example, a dictionary option may be presented so that the user may choose an appropriate term from a list of terms saved on the dictionary. An image database may be used to compare prior images to presently reviewed images, etc. Multiple monitors may be used to display image and other data.

According to an embodiment of the invention a user can create a report per case. According to one embodiment the term “case” may include a single capsule endoscopy procedure performed on a patient. Several cases can exist for the same patient. According to one embodiment each case is identified by an ID, which exists in each of its data files. Case data files may consist of, for example, videos, findings and reports. Other files or data may be included in a case. According to another embodiment, the term “case” may refer to other medical procedures such as endoscopic procedures, radiographic procedures, etc.

A typical procedure may include a patient check-in process which enables entry and storage of all patient data. Typically, patient information is entered through the work station to the receiver 12. This information is important in identifying a patient with the video to be created from the raw data saved in the receiver 12. Checking in a patient may be performed through a check in window in which a “patient check in” wizard may open and which may lead the user through the process of checking in a patient. Information that may be entered by the user may include patient details, such as ID, gender, birth date and details regarding the patient physique such as weight, height and waist. Other information that may need to be entered during this process may include details regarding the type of receiver being used (e.g., standard or pediatric) or the type of procedure (e.g., procedure for the esophagus, for the small bowel, for the colon, etc.).

According to an embodiment of the invention a user can re-save a video with corrected patient info, even after the video is downloaded. According to an embodiment of the invention the old information will be saved in an audit trail, for example, within test files (having a .gvi extension, for example). An audit-log user interface (UI) will display the patient info change history.

According to an embodiment of the invention reports can be created in HTML format or in PDF format for facilitated exporting of reports to electronic medical records (EMRs).

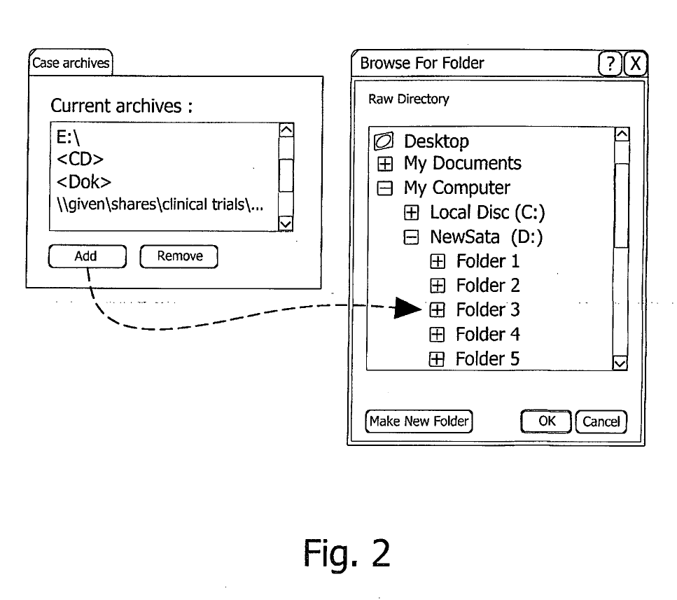

Reference is now made to FIG. 2 which is a schematic presentation of a user interface according to one embodiment of the invention. The exemplary user interface shown in FIG. 2 illustrates an archiving feature that may be used according to one embodiment of the invention. According to one embodiment a case archive is a directory of videos. According to another embodiment a case archive is a location for storing case-related data. According to other embodiments archives may include other directories or files. Archives can exist in numerous places, for example, a directory on a hard drive, on a CD, in a network folder, on a Disk on Key or Maxtor-style external USB Disk. An archive may exist in other appropriate places. According to one embodiment a case management tool looks inside all known archives. According to one embodiment a settings dialog may contain a ‘case archives’ tab that enables selection of archive root folders. According to one embodiment archives will be identified according to a unique ID (such as volume ID, or volume name), rather than according to drive letter (which can change between insertions). Additionally, two different archives may have the same volume ID if, for example, both reside on the same local drive. So in order to uniquely identify an archive it would be preferable to use both the archive drive which is the path as was entered by the user and the unique ID.

According to one embodiment archives are displayed according to their drive letter name plus volume name and volume type. An “Add” button may be used to add archives to the ‘case archives’. The “add” button may use a directories dialog box.

A method according to an embodiment of the invention provides updated case archives so that a user may access all the relevant information each time he accesses a case. According to one embodiment a user may add archives to the case archive by using a button in a dialog box. The user may be presented with a list of locations where cases are searched in. For example, local drives, network drives or removable media such as CD and USB memory cards. The user will be able to add locations if there are cases in additional locations that do not appear in the current list of archives or can remove locations that are no longer relevant. According to one embodiment, the method includes automatically detecting various removable storage devices available, for example CDs, USB storage devices, etc., and creating archives for these devices. According to one embodiment, the method includes identifying when such media is removed from the system and removing these archives accordingly from the system.

According to an embodiment of the invention a user can copy any case data element such as a video, a report, physician's findings, patient information, etc. from one archive to another archive or to multiple archives. A user can or save updated case data elements in different archives.

A software may be provided that keeps an up to date status of the various cases that were viewed or constructed by monitoring the status of files on the file system, for example, in the work station. A list of cases can be built to include cases that are being viewed and manipulated by the user. According to one embodiment an internal log is updated with each of a user's actions on a data file, for example, a video file, that will later become a searchable list of actions. According to one embodiment a system is provided that creates a log of the items that were accessed by the user and the accompanying information of these items. The log is updated with new entries, can modify existing entries or delete entries as a response to events of specific actions that the user does. For example, such actions may include opening a new video, deleting a video, creating new locations, creating new findings, creating new reports and so on. According to one embodiment the user is able to browse this log in a graphical manner.

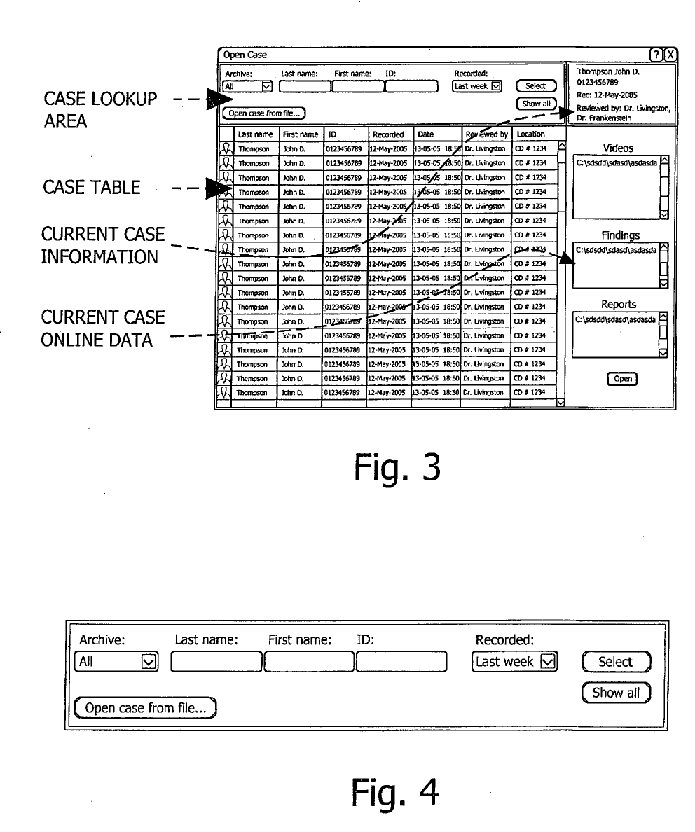

Reference is now made to FIG. 3 which is a schematic presentation of a method and user interface according to one embodiment of the invention. According to one embodiment a user interface may include a case window which may include features relating to each case, such as: case lookup, case table, current case information and current case online data. Other features may be displayed according to other embodiments.

A “case table”, according to one embodiment, may display a set of requested cases. For example the table may display all cases sharing a pathology or diagnosis, or other groups of cases based on a different parameter. According to one embodiment the table may display details of each case. For example the table may display, for each case, columns of, for example, Patient information, Relevant case related information (e.g. test date, case status, available reports, findings, video files, etc.), and other relevant information. According to one embodiment the table is an SQL (Structured Query Language) database. The database may contain several tables, each of them holding specific information, and by combining information from the different tables, the user may be presented with the full data. According to one embodiment queries by a user will not need to retrieve all the stored information in the tables, but only a part of it—for example just the patients' names. By dividing the data into logical structure of tables, such queries can take place only on the relevant tables.

According to one embodiment by clicking on an online data element, the user may be able to view that data element. For example, if the user clicks on a PDF report, the user will be presented with the report. For findings, the procedure may be somewhat different, since findings are typically associated with actual videos. Therefore, if the user requests to open a finding and several videos exist for this finding the user may be asked which associated video to open as well.

According to an embodiment of the invention the linkage between a case and its components is saved in the database. Once a user clicks on a case, which is identified uniquely by a test ID GUID, the cases table will be queried for the paths of the findings which contain the same test ID GUID. This query will allow the table to update the current case information with the case's components. Report files and other types of case related files may be associated to a specific case using the same test ID GUID. For example, a test ID GUID may be embedded in the name of the file. In another example, the test ID GUID may be embedded in the file data.

According to one embodiment of the invention, various types of case related data elements are saved in the database, such as video files, findings, reports, case history, etc. According to one embodiment of the invention, a data heading may include the title, name, or label of a specific case-related data element. In some embodiments, only case related data headings are saved in the database. In other embodiments, both case related data elements and data headings are saved in the database.

The archives are typically continuously monitored, in the background, for changes. If an existing archive is modified, for example, by having cases added, deleted or modified, the table will reflect those changes. For example, if a video was deleted from a network share, the table will be updated and will not show the corresponding case data element anymore.

In addition, these updates may be performed in parallel so that a long update from one archive will not block changes from other archives.

According to one embodiment a case will be considered online if it has an online video or if it has an online report. The database may contain the online/offline status of a case and if this status is changed due to changes in the archive, the database is updated accordingly.

An algorithm for updating the case files (e.g., videos, findings and reports), according to one embodiment, is intended to synchronize the information that is located in the online archives versus the information stored in the database. According to one embodiment an algorithm may include the following steps:
For each ONLINE archive-pointer
   Identify archive
   For each directory in archive [recursively parse the file system]
      Clear all CaseFiles.Marked for the current archive and directory
      For each file in directory on file system
      If found a new file, add it to CaseFiles and mark
      If file exists (with a modified or an identical modification time) mark
      Remove all the unmarked files of this archive (for example, using Archived)

According to one embodiment the case management module may register for file system notifications that are issued by the file system whenever an operation on the file system occurs.

In some cases, the user may want to compress all case data currently available, for example, video segments, findings, reports and patient information. According to one embodiment the case management tool allows the user to pack all available case data into a single zip file, the user can then use that single file instead of dealing with multiple files and directories. According to one embodiment the packed data is created in ZIP format.

According to one embodiment the UI may include an icon showing what type of data is known (e.g., videos/findings/reports). The icon may be presented in proximity to the case information. According to some embodiments an indication (for example by highlighting or using different colors) may be used to show a user which cases have online data. Other methods of display may be used.

According to one embodiment the table may include a header to enable sorting via each column. Sorting may be done by other methods.

According to one embodiment only cases from known archives will be displayed in the table, although a UI may exist to open cases from other paths, as further detailed below.

The features according to the embodiment illustrated in FIG. 3 may enable easy finding of cases and easy opening of case data.

According to one embodiment the case lookup area, an enlarged presentation of which is shown in FIG. 4, enables searching for sub-groups, for example, to search for a specific archive, a patient name, a test date etc. For example, if a user started watching a video and then decides to open case related data such as findings or reports a dialog box may be displayed, which will present a list of all available case related data and allow the user to open associated findings and reports with the current video he is watching. In addition, the dialog may let the user open a specific file even if it is not a part of the archives. This functionality may be achieved by querying the database for all the case's specific files or case related data elements, online or offline, and displaying the list of data elements to the user to choose which files he wants to open.

A ‘show all’ option may enable showing a set of cases, for example, all known cases.

Archives may have ‘all’ or ‘all online’ options for showing all known cases or all online cases from the known archives. Other options may be included. An ‘open from file . . . ’ button may enable opening videos directly, for example, from a GVI format.

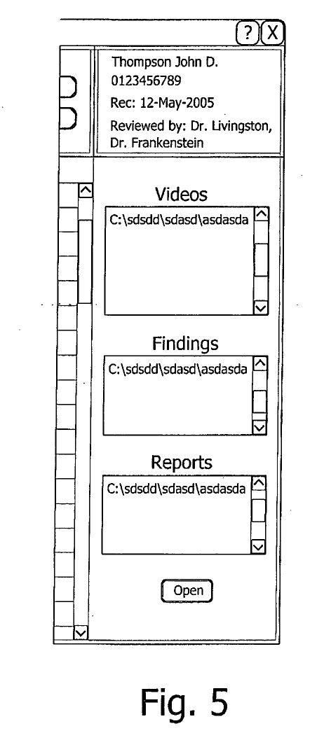

According to one embodiment the current case information, an enlarged presentation of which is shown in FIG. 5, shows, for the current selected case in the case table, an area containing helpful features such as:
Detailed information about the case, including patient & test details, etc.
A list of all known videos, and which are online (for example, highlighting or using color).
A list of all known findings, and which are online (for example, highlighting or using color).
A list of all known reports, and which are online (for example, highlighting or using color).
According to one embodiment the case information area is vertical, and connects clearly to the currently selected case. Other types of display may be used.
According to one embodiment pressing on any of the online data will open it. For each data, the volume name on which it is saved may appear (for example, to help in CD and external disk identification). If, for example, many videos exist and a finding is requested, then the user may be asked which video to open.
For displaying online information all known archives are continuously monitored in the background for changes—in parallel. A case will be considered online if it has an online video or if it has an online report.
According to one embodiment the case management is able to perform syncs with read-only archives such as CDs.
A box such as that illustrated in FIG. 5 may also include buttons to enable opening an external file (e.g., files that are not within an archive), directly and not by clicking on a table entry. This feature can enable easy opening of case related data while the case is displayed.

It will be appreciated by persons skilled in the art that the present invention is not limited by what has been particularly shown and described hereinabove. Rather the scope of the invention is defined by the claims that follow:

1. A system for management of medical data comprising:
an in vivo imaging device for capturing images in a patient's body;
a transmitter for transmitting data representing said images;
a receiver external to the patient's body for receiving the transmitted data;
a data processor capable of analyzing data;
a data processor storage unit;
an image monitor capable of displaying analyzed data; and
a case management tool comprising a user interface, said case management tool capable of presenting a list of all case related data elements per case.

2. The system according to claim 1 wherein the storage unit comprises a database.

3. The system according to claim 2 wherein said database comprises a parameters database or an image database or a combination thereof.

4. The system according to claim 2 wherein said database comprises case-related files.

5. The system according to claim 2 wherein the database is remote.

6. The system according to claim 2 wherein the database is accessible via a network.

7. The system of claim 1 wherein the case management tool comprises a case archive.

8. The system of claim 6 wherein the case archive exists in numerous locations.

9. The system of claim 1 wherein monitoring software is provided to keep an up to date status of case related data.

10. The system of claim 1 wherein the user interface displays information change history.

11. The system of claim 1 wherein the receiver comprises:
a data processor capable of analyzing in-vivo data and a storage unit.

12. The system of claim 1 wherein the receiver comprises an image monitor to display analyzed in-vivo images.

13. The system of claim 1 wherein the user interface presents case related data in addition to the list of case related data elements.

14. The system of claim 1 wherein the user interface provides an indication of online status of each case related data element in the list.

15. The system of claim 1 wherein the user interface provides a log of user actions.

16. A method for management of medical data, the method comprising:
monitoring archives for changes in case related data elements, thereby finding updated data elements;
associating between the updated data elements and cases in a case management database;
synchronizing the case management database with the updated data elements;
summarizing the synchronized data; and
providing the summarized data per case to a user.

17. The method of claim 16, comprising identifying case related data elements in archives.

18. The method of claim 16, comprising:
collecting in vivo data received from an in vivo imaging device;
creating case related data elements from the in vivo data; and
storing the case related data elements in archives.

19. The method of claim 16, wherein the summarized data per case comprises data that is located on a workstation or data that is located in remote locations, or a combination thereof.

20. The method of claim 16, wherein the summarized data per case is updated.

21. The method of claim 16, wherein the summarized data per case is periodically updated.

22. The method of claim 16, comprising providing information change history in graphic representation.

23. The method of claim 16, comprising providing a log of user actions in graphic representation.

24. The method of claim 16, comprising providing a list of case related data elements in graphic representation.

25. The method of claim 16, comprising providing a list of case related online data elements in graphic representation.

26. The method of claim 16, wherein the user interface provides cross reference to data elements in other locations

27. The method of claim 16, comprising:
detecting available storage devices automatically; and
creating archives for said devices automatically.
